(19) United States
(12) Patent Application Publication
(10) Pub. No.: US 2015/0227861 A1
(43) Pub. Date: Aug. 13, 2015

(54) COLLABORATIVE CUSTOMER RELATIONSHIP MANAGEMENT METHODS AND SYSTEMS

(71) Applicant: Yapmo, LLC, Chicago, IL (US)

(72) Inventors: Paul Everton, Chicago, IL (US); Erich Luedtke, Chicago, IL (US); Raymond Elward, Chicago, IL (US)

(21) Appl. No.: 14/666,359

(22) Filed: Mar. 24, 2015

Related U.S. Application Data
(63) Continuation of application No. 13/783,641, filed on Mar. 4, 2013, now abandoned.

(51) Int. Cl. G06Q 10/06; G06F 3/0484; G06F 17/30

(52) U.S. Cl. CPC G06Q 10/06; G06F 17/3089; G06F 3/04842

(57) ABSTRACT

A computing system may comprise a customer relationship management (CRM) database and a server that hosts an electronic forum. The computing system may generate a case study based on contents of the CRM database, and may post the case study to the electronic forum. The case study may be generated in response to a change in the contents of one or more first selected fields of one or more records of the CRM database. The case study comprises the content of one or more second selected fields of the one or more records of the CRM database. The one or more first selected fields and/or second selected fields may be selected based on one or more user-defined rules stored in memory of said computing system.

### CLAIM OF PRIORITY

This patent application is a continuation of U.S. patent application Ser. No. 13/783,641 filed on Mar. 4, 2014, which is hereby incorporated herein by reference in its entirety.

### TECHNICAL FIELD

Aspects of the present application relate to computing networks. More specifically, to methods and systems for collaborative customer relationship management.

### BACKGROUND

Existing systems and methods for customer relationship management can be inefficient. Further limitations and disadvantages of conventional and traditional approaches will become apparent to one of skill in the art, through comparison of such approaches with some aspects of the present method and system set forth in the remainder of this disclosure with reference to the drawings.

### BRIEF SUMMARY

A method and/or system is provided for collaborative customer relationship management as illustrated by and/or described in connection with at least one of the figures, as set forth more completely in the claims.

### BRIEF DESCRIPTION OF THE DRAWINGS

FIG. 1 depicts an example computing environment for customer relationship management and collaboration.

FIGS. 2-6 depict example user interface elements of a system for customer relationship management and collaboration.

FIG. 7 is a flowchart illustrating an exemplary process performed by a system for customer relationship management and collaboration.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “exemplary” means serving as a non-limiting example, instance, or illustration. As utilized herein, the term “e.g.,” introduces a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

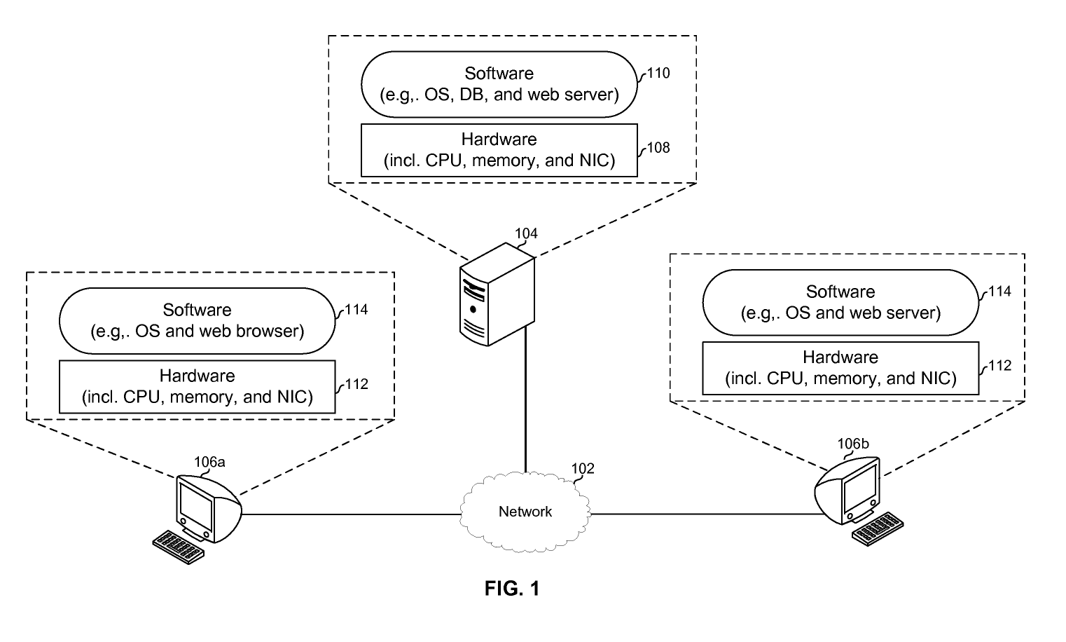

FIG. 1 depicts an example computing environment for customer relationship management and collaboration. Shown are a network 102, a computing device 104, and computing devices 106a and 106b. Examples of computing devices include: desktop computers, laptop computers, tablet computers, smartphones, stand-alone servers, rack-mounted servers, and the like. In an example implementation, the computing device 104 may operate as a web and/or application server (e.g., may be a stand-alone or rack-mounted server), and the computing devices 106a-106b may each operate as an end-system (e.g., may be a personal computer, tablet computer, or a smart phone).

The network 102 may comprise a local area network and/or a wide area network. The network 102 may comprise, for example, network “plumbing” such as routers, switches, cables, etc. The network 102 may be, for example, the Internet and/or an Ethernet-based LAN.

The computing device 104 may comprise circuitry operable to process (e.g., read from memory, perform logic and/or arithmetic operations on, packetize according to one or more communication protocols, and/or the like) data to be sent via a network connection, send data via a network connection, receive data via a network connection, and process (e.g., write to memory, perform logic and/or arithmetic operations on, depacketize according to one or more communication protocols, and/or the like) data received via a network connection. Such data may include, for example, data formatted and communicated in accordance with one or more Internet-related standards (e.g., HTML, HTTP, TCP/IP, etc.), and/or in one or more vendor-specific Application Programming Interfaces (APIs). Such circuitry may enable each of the computing device 104a to operate as a web server and/or a vendor-specific application server.

The memory circuitry may comprise, for example, SRAM, DRAM, ROM, FLASH, magnetic storage, and/or any other suitable type of memory. The memory circuitry may store program memory, run-time memory, and/or mass storage. The memory circuitry may store data associated with an electronic forum hosted by the device (e.g., HTML files, CSS files, script files, posted content, posted attachments, user account information, and/or the like.). The user account information may include, for example, biographical information, user preferences, a user activity log, and/or user attributes. The biographical information may include, for example, name, address, contact info, work title, and/or the like. The user preferences may include, for example, which categories, tags, etc. that the user is interested in (e.g., manually set by the user and/or automatically populated based on the user's activity). The memory circuitry may store data associated with a customer relationship management (CRM) database hosted by the device 104 (e.g., information about existing and potential customers, information about open sales opportunities, information about closed sales opportunities, and/or the like).

The circuitry of the computing device 104 may comprise, for example hardware 108 and software 110. The hardware 108 may comprise, for example, a CPU, memory circuitry, and network interface circuitry (NIC). The software 110 may comprise, for example, an operating system, one or more database applications, and a web server application. The database application(s) may, for example, store, organize, and/or provide access to data of an electronic forum and/or CRM data. The web server may, for example, serve a graphical user interface of the electronic forum and/or CRM database.

The CPU may comprise, for example an x86-based processor, an ARM-based processor, or any other suitable circuitry operable to execute instructions (e.g., stored in the memory of hardware 108) for processing data, generating control signals, and/or otherwise performing, or causing other circuits to perform, functions described herein. In this manner, an operating system and one or more software applications may run on the computing device 104. Such software applications may include, for example, a CRM database, a web server, an application server, and/or processes for performing various aspects of a communication protocol (e.g., for implementing TCP/IP and interfacing the applications to the network 104).

The network interface circuitry may be operable to transmit and receive physical layer signals via the network. In the receive direction, the network interface circuitry may convert the signals to packets of binary data, and output the packets to the CPU and/or memory for processing. The network interface circuitry may, for example, receive signals in accordance with Ethernet physical layer protocols, assemble the signals to IP packets and output the IP packets to the CPU and/or memory. In the transmit direction, the network interface circuitry may receive IP packets from the CPU and/or memory, encapsulate the IP packets into Ethernet frames, and transmit the frames into the network 102 in accordance with Ethernet physical layer protocols.

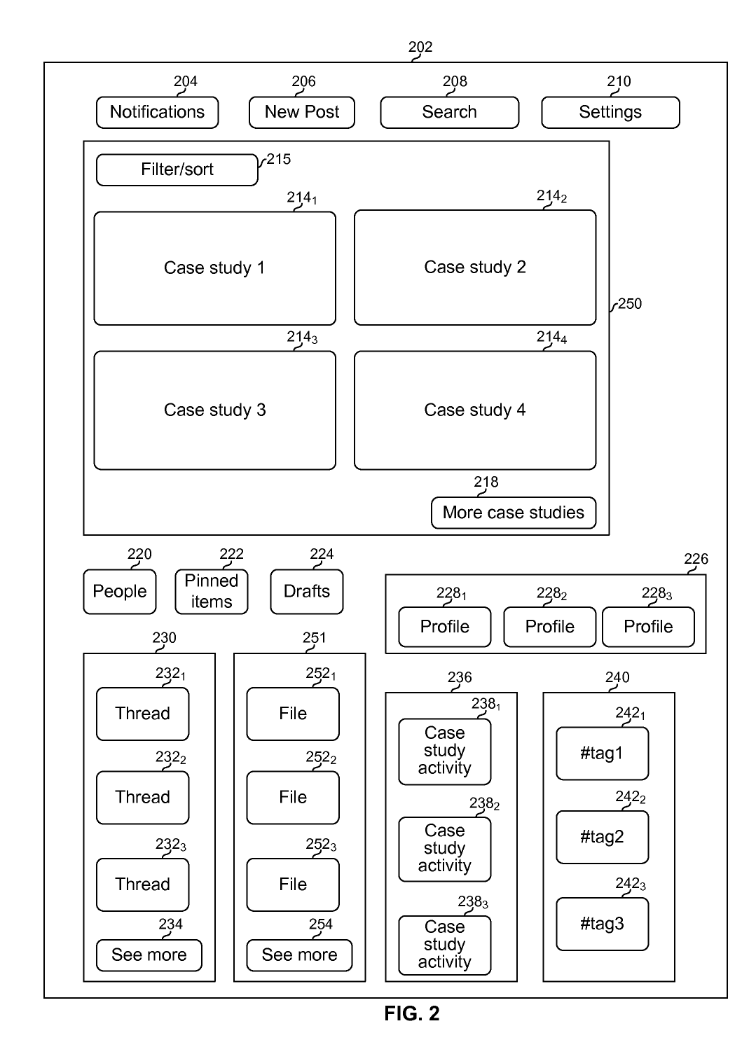

In operation, the computing device 104 may operate as a web server to host an electronic forum and an interface via which users can interact with CRM data as, for example, described below with reference to FIGS. 2-6.

Each of the computing devices 106a and 106b may comprise circuitry operable to process (e.g., read from memory, perform logic and/or arithmetic operations on, packetize according to one or more communication protocols, and/or the like) data to be sent via a network connection, send data via a network connection, receive data via a network connection, process (e.g., write to memory, perform logic and/or arithmetic operations on, depacketize according to one or more communication protocols, and/or the like) data received via a network connection. Such data may include, for example, data formatted and communicated in accordance with one or more Internet-related standards (e.g., HTML, HTTP, TCP/IP, etc.), and/or in one or more vendor-specific Application Programming Interfaces (APIs). Such circuitry may enable each of the end-systems 106a-106c to operate as a web client, and/or run a vendor-specific application client. Additionally or alternatively, the circuitry may enable the computing devices 106a and 106b to present web-based content to a user (e.g., via speakers and/or a monitor) and accept input from a user (e.g., via touchscreen, keyboard, mouse, and/or the like).

The circuitry of the computing devices 106 may comprise, for example hardware 112 and software 114. The hardware 112 may comprise, for example, a CPU, memory circuitry, and network interface circuitry (NIC). The software 114 may comprise, for example, an operating system, a web browser application, and/or a vendor-specification client application (e.g., a CRM client application and/or an electronic forum client application).

The memory circuitry may comprise, for example, SRAM, DRAM, ROM, FLASH, magnetic storage, and/or any other suitable type of memory. The memory circuitry may store program memory, run-time memory, and/or mass storage.

The CPU may comprise, for example an x86-based processor, an ARM-based processor, or any other suitable circuitry operable to execute instructions (e.g., stored in the memory of hardware 112) for processing data, generating control signals, and/or otherwise performing, or causing other circuits to perform, functions described herein. In this manner, an operating system and one or more software applications may run on each computing device 106. Such software applications may include, for example, a web browser, a vendor-specific application client, and/or processes for performing various aspects of a communication protocol (e.g., for implementing TCP/IP and interfacing the applications to the network 104).

The network interface circuitry may be operable to transmit and receive physical layer signals via the network. In the receive direction, the network interface circuitry may convert the signals to packets of binary data, and output the packets to the CPU and/or memory for processing. The network interface circuitry may, for example, receive signals in accordance with Ethernet physical layer protocols, assemble the signals to IP packets and output the IP packets to the CPU and/or memory. In the transmit direction, the network interface circuitry may receive IP packets from the CPU and/or memory, encapsulate the IP packets into Ethernet frames, and transmit the frames into the network 102 in accordance with Ethernet physical layer protocols.

In operation, case studies comprising selected data from the CRM database may be automatically generated and posted to the electronic forum in response to changes in the CRM data. A computing device 106 (referring to either or both of computing devices 106a and 106b) may access the case study by logging into the electronic forum. A web browser (or vendor-specific “app”) running on the computing device 106 may request content (e.g., a posted case study, comments to the case study, and/or attachments to the case study) by, for example, sending HTTP requests (or in accordance with a vendor specific API) to the computing device 104. Received packets carrying requested content may be processed by network interface circuitry and/or CPU of the device 106 to recover the content and store it to memory of the device 106. The web browser (or “app”) may then cause the content to be rendered for presentation (e.g., by the CPU) in a window on a monitor of the device 106.

FIGS. 2-6 depict example user interface elements of a system for customer relationship management and collaboration

Referring to FIG. 2, there is shown an example window (or screen) 202 of a graphical user interface of electronic forum integrated with a CRM database. The window/screen may, for example, be presented on a monitor of device 106a and be interacted with via a mouse and keyboard of the device 106a. The example window 202 comprises a plurality of interface elements each which may be hyperlinks, text boxes, drop down menus, and/or the like.

Element 204 may be a link that, when interacted with (e.g., touched, clicked, or the like) brings up a window in which notifications for the user are displayed (e.g., an “inbox” of messages, statuses, and the like pertaining to case studies and/or other activity in forum. Element 206 may be a link that, when interacted with, brings up a form for generating a new case study (e.g., a manually generated or “one-off” case study). The form may have, for example, elements for entering: the title of the post, a description of the post, a categorization of the post, for associating tags with the post, and the like. In an example implementation where manually-generated case studies may be posted, the form may comprise elements for defining rules as to when the case study should post (e.g., based on selected CRM fields having specified contents) and/or for defining rules as to the contents of the case study (e.g., which CRM fields should be placed in the body of the case study). Upon submission of the form, a thread and/or post may be created in the forum and other users may be enabled to view and reply to it. Element 208 may be, for example, a text-box for entering search queries for searching case studies, posts, attachments, and/or any other content of the forum. Element 210 may be a link that, when interacted with, brings up a window for configuring the user's profile and/or preferences. Interface elements 204-210 may be part of a “navigation bar” of the window/screen 202.

Element 250 comprise “at-a-glance” information about generated case studies. For example, each time the window 202 is loaded, a plurality of case studies may be algorithmically selected and displayed as elements 214, each of which comprises information about a particular case study (e.g., associated business unit, the customer, employees, and/or the like) and its status (e.g., whether a sales opportunity is “open” or “closed”). For example, the selection of which case studies are displayed as elements 214 may be random. As another example, the selection may be based on characteristics of the case studies (e.g., time generated), the user profile of the user viewing the window 202 (e.g., case studies that pertain to customers, business units, technology sectors, etc. that the user is associated with in his/her account profile), tags the user has indicated an interest in, case studies submitted by other users that are associated with the viewing user in a company organization chart, and/or the like. Element 250 may also comprise a link 218 which, when interacted with, may bring up a window for viewing additional case studies. Element 250 may also comprise a link 215 which, when interacted with, may bring up a window for filtering and/or sorting the case studies presented in element 250.

Element 220 may be a link that, when interacted with, brings up a list of users of the forum. Element 222 may be a link that, when interacted with, brings up a window in which case studies, posts, attachments, and/or other content of the forum that the user has previously selected to be saved (“pinned”) can be viewed, edited, and/or the like. That is, the element 222 may bring up the user's personal/customized space on the forum. Element 224 may be a link that, when interacted with, brings up a window in which the user's drafts of case studies to be submitted, comments for previously posted case studies, messages to be sent, and/or the like are saved and can be viewed, edited, and/or the like.

Element 226 may comprise “at-a-glance” information about recent activity on the forum. For example, element 226 may comprise links 228₁-228₃ each of which corresponds to a user who recently commented on a case study, caused the generation of a case study, and/or otherwise generated activity on the forum.

Element 230 may comprise “at-a-glance” information about recent comment/discussion activity on the forum. For example, element 230 may comprise hyperlinks 232₁-232₃, corresponding to three recent posts. Each element 232 may, for example, display a summary of the post, the author of the post, tags associated with the post, etc. The element 230 may also comprise element 234 which brings up a window via which posts beyond the recent ones associated with elements 232 can be viewed and interacted with.

Element 250 may comprise “at-a-glance” information about recent files posted to the forum. For example, element 250 may comprise hyperlinks 252₁-252₃, corresponding to three recent files (e.g., word processor files, spreadsheet files, images, videos, etc.). Each element 252 may, for example, display a summary of the file, the author/poster of the file, tags associated with the file, etc. The element 230 may also comprise element 254 which brings up a window via which files beyond the recent ones associated with elements 252 can be viewed and interacted with.

Element 236 may comprise “at-a-glance” information about recent case study activity on the forum. For example, element 236 may comprise hyperlinks 238₁-238₃, corresponding to three recently generated case studies (e.g., in response to three recently updated CRM records) and/or recent comments/replies to case studies. Each element 238 may, for example, display a summary of the activity and/or case study, the user associated with the activity and/or case study, tags associated with the activity and/or case study, etc.

Element 240 may comprise “at-a-glance” information about recent popular topics, posts, etc. on the forum. For example, element 240 may comprise hyperlinks 242₁-242₃, corresponding to the three most-popular tags over a determined time interval.

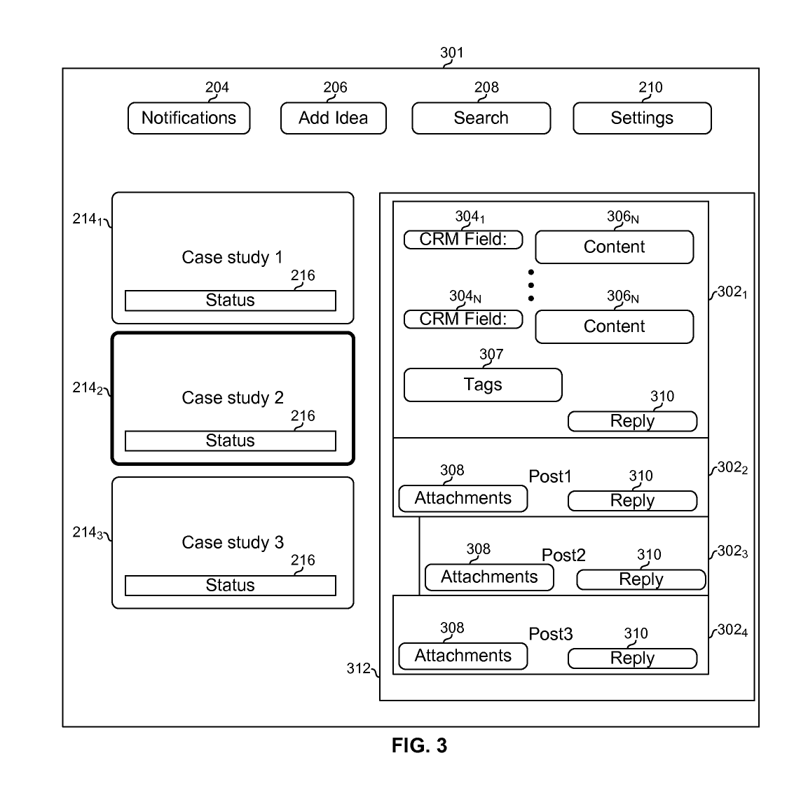

Referring to FIG. 3, there is shown an example window (or screen) 302 of a graphical user interface of an electronic forum integrated with a CRM database. The window/screen 302 may, for example, be presented on a monitor of device 106a and be interacted with via a mouse and keyboard of the device 106a. The example window 302 comprises a plurality of interface elements each which may be hyperlinks, text boxes, drop down menus, and/or the like. The window 302 may, for example, be displayed in response to interacting with one of the elements 214 of FIG. 2. In the example scenario shown, the window 302 is displayed in response to element 214₂ having been selected (as indicated by the heavy line).

The elements 204-210 and 214 may be as described above with reference to FIG. 2. The element 312 may comprise elements 302 each of which may contain content pertaining to a particular case study (“Case Study 2” in the example depicted).

A first element 302₁ may comprise the case study. The element 302₁ may comprise elements 304₁-304_{N}, elements 306₁-306_{N}, 208, and 310. Each of the elements 304₁-304_{N} may be one of N (an integer) CRM fields selected by a user or administrator to be placed in the case study. Each of the elements 306₁-306_{N} may comprise contents of a corresponding one of the selected CRM fields. For example, field 304₁ may be a “Customer Name” field for a particular CRM record and the corresponding field 306₁ may contain “CompanyX.”

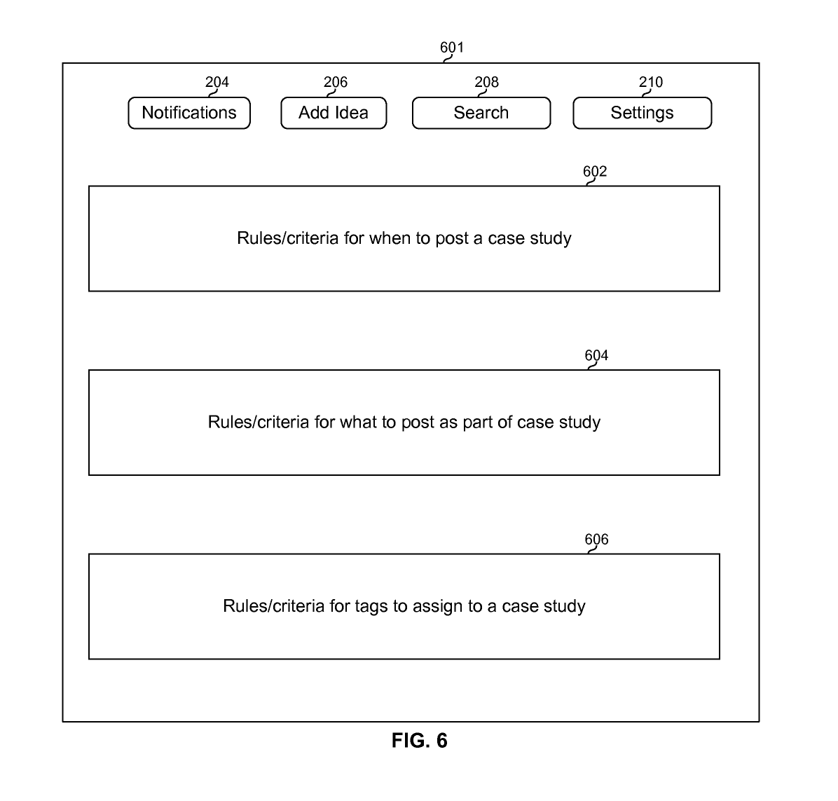

The case study 302₁ may be automatically generated and posted in response to a user-defined rule (e.g., defined by a forum administrator using an interface such as is described with reference to FIG. 6 below) for generating and posting case studies. In an example implementation, a user-defined rule may cause the case study to be posted in response to a sales representative creating or closing a sales opportunity in the CRM database. In the former case, the case study may, for example, be generated and posted in response to the sales representative creating a record in the CRM database. In the latter case, the case study may, for example be generated and posted in response to the sales representative changing a status field of the CRM record to “closed.”

Which fields of the CRM record corresponding to the potential or closed sale are displayed as elements 304₁-304_{N} may be determined based on one or more user-defined rules (e.g., defined by a forum administrator using an interface such as is described with reference to FIG. 6 below). In an example implementation where the case study corresponds to a sales opportunity, selected CRM fields may include, for example: the name of the potential customer, the industry and/or market that the potential customer operates in, the potential product or service to be sold, others entities competing for the potential customer's business, important dates, a narrative field where the sales representative can input miscellaneous information, and/or the like.

The element 308 may comprise one or more tags associated with the case study. In an example implementation, tags associated with the case study may be determined based on one or more user-defined rules (e.g., defined by a forum administrator using an interface such as is described with reference to FIG. 6 below).

The element 310 may when interacted with, bring up a form for submitting a comment/reply to the case study 302₁. The reply may then be displayed as a second element 302 in the element 312. Each of the remaining elements 302₂-302₄ may be comments/replies to one or more of the case studies and comments/replies in the element 312. For example, in the scenario shown, 302₂ and 302₄ are replies to 302₁, and 302₃ is a reply to 302₂.

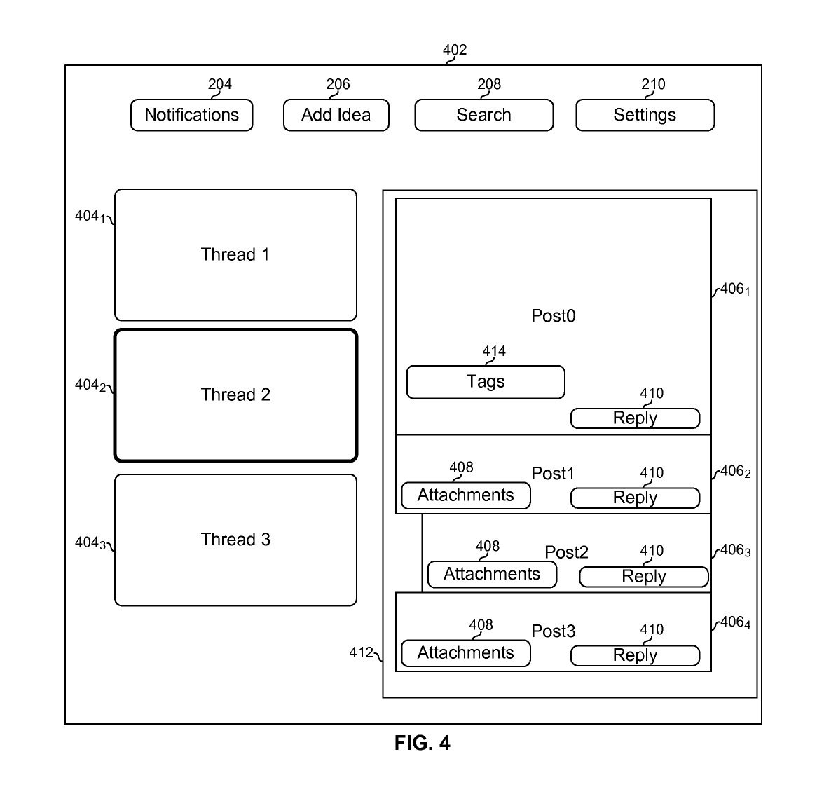

Referring to FIG. 4, there is shown a window 402 which is similar to the window 302 of FIG. 3. Whereas the window 302 comprises elements pertaining to particular case studies, window 402 provides a more general discussion forum.

Each of the elements 404 may correspond to a thread. The element 412 may comprise elements 406 corresponding to posts of the selected thread. The element 406₁ may correspond to the first post (“Post 0”) of the thread. The element 414 may indicate one or more tags that are associated with the post and/or the selected thread. Which tags are associated with the post may be manually selected by an author of the post and/or may be automatically selected based on the contents of the thread and/or one or more user-defined rules. The elements 408 and 410 may be substantially similar to the elements 308 and 310, respectively, of FIG. 3.

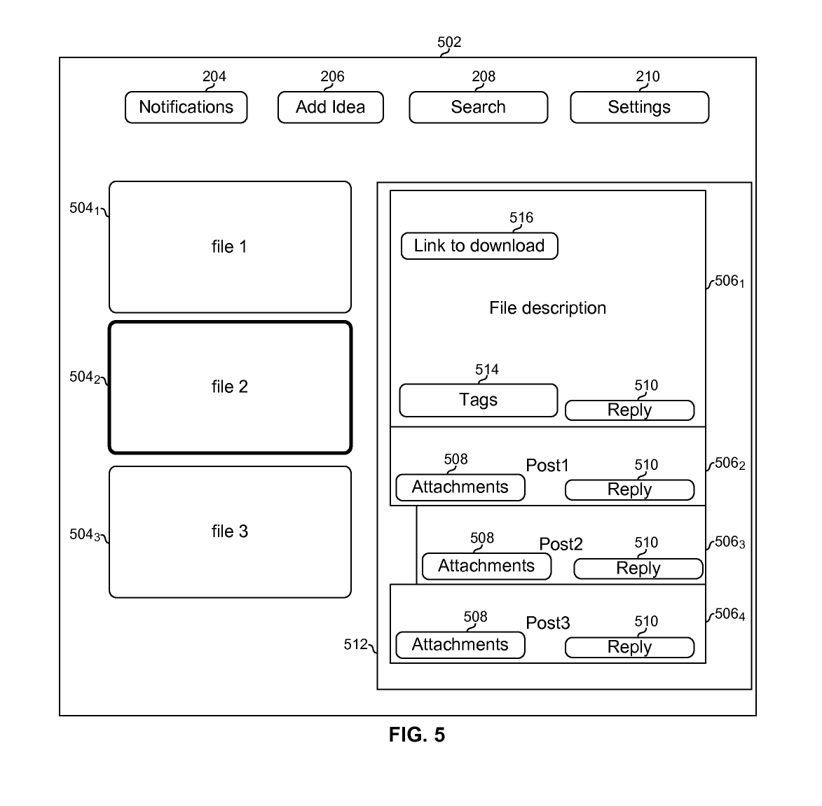

Referring to FIG. 5, there is shown a window 502 which is similar to the window 402 of FIG. 4. Whereas the window 402 comprises elements of a general discussion forum, window 502 comprises elements corresponding to files associated (e.g., by attaching to posts) with the electronic forum.

Each of the elements 504 may correspond to a respective file. (i.e., 504₁ may correspond to a first file, 504₂ may correspond to a second file, and so on). The element 512 may comprise elements 506 corresponding to posts associated with the selected file. The element 506₁ may correspond to the first post (“Post 0”) of the thread. The element 516 may comprise a link to download the file associated with the thread. The element 514 may indicate one or more tags that are associated with the file. Which tags are associated with the file may be manually selected by the user who posted the file and/or may be automatically selected based on the contents of the thread to which the file was posted and/or one or more user-defined rules. The elements 508 and 510 may be substantially similar to the elements 408 and 410, respectively, of FIG. 4. In an example implementation, the files displayed in the window 502 may be attached to case studies as shown in FIG. 3 and/or threads as shown in FIG. 4. In this regard, the window 502 may aggregate files from across multiple threads or case studies. In this manner, a user may be enabled, for example, to find related files and/or particular versions a file.

FIG. 6 depicts an example user interface for creation of user-defined rules pertaining to the generation and posting of case studies. The depicted window comprises an element 602 for defining rules as to when case studies are to be generated and posted to the forum, an element 604 for defining rules as to what contents to include in a generated case study, and an element 606 for defining rules as to what tags are to be associated with a generated case study.

The element 602 may comprise elements such as, for example, drop-down menus, check boxes, text boxes, and/or the like for a user (e.g., a forum administrator) to define rules as to when case studies are to be generated and posted to the forum. In an example implementation, the element 602 may comprise elements for selecting one or more fields of the CRM database and defining logic expressions based on the contents of the selected field(s). For example, a rule that a case study should be created upon closing of a sales opportunity (i.e., create case study when contents of a status field in the CRM is set to “closed”) may be defined by selecting a “status” field via a first checkbox or drop-down menu, selecting the logic expression “is equal to” via a second checkbox or drop-down menu, and selecting “closed” via a third checkbox or drop-down menu.

The element 604 may comprise elements such as, for example, drop-down menus, check boxes, text boxes, and/or the like for a user (e.g., a forum administrator) to define rules for what content to include in case studies. In an example implementation, the element 604 may list each of a plurality of CRM fields and the user may be enabled to check which of the fields to include in generated case studies.

The element 606 may comprise elements such as, for example, drop-down menus, check boxes, text boxes, and/or the like for a user (e.g., a forum administrator) to define rules for what tags to associate with generated case studies. In an example implementation, the element 606 may list each of a plurality of CRM fields and the user may be enabled to check which of the fields should be converted to tags. For example, where a particular CRM field is selected in element 606, a generated case study may be tagged with the contents of the selected field.

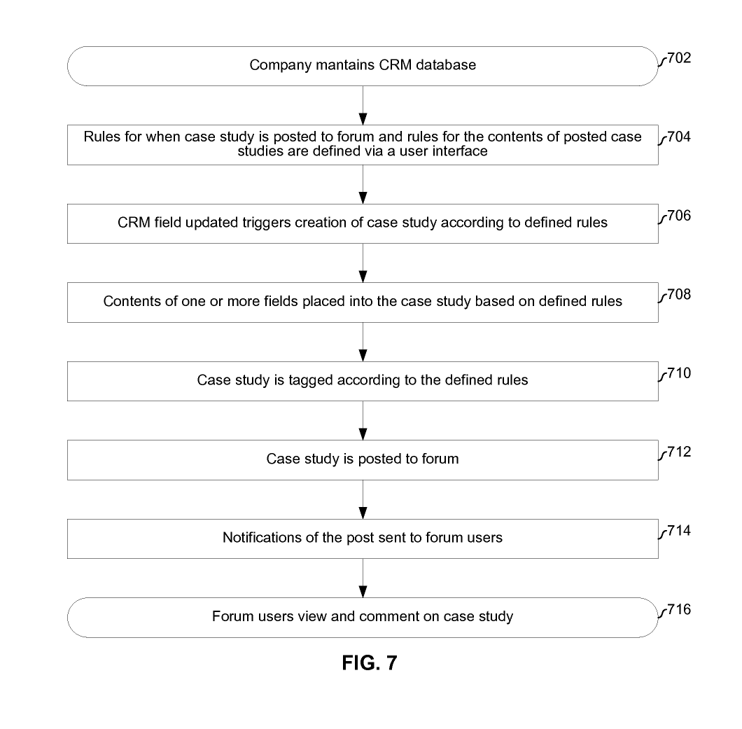

FIG. 7 is a flowchart illustrating an exemplary process performed by a system for customer relationship management and collaboration. The process begins with block 702 when a company has set-up a CRM database and is using it for managing data.

In block 705, rules for when case studies are to be posted to the electronic forum, and rules for the contents of the posted case studies, are defined by a user (e.g., a forum administrator) using an interface such as the one described with reference to FIG. 6.

In block 706, an update of a CRM field triggers the creation and posting of a case study, in accordance with the rules defined in block 704. For example, a sales representative changing a sales opportunity status field to “closed” may trigger the creation of the case study.

In block 708, the case study is generated with its contents populated with the contents of one or more CRM fields, in accordance with the rules defined in block 704. For example, the case study may be populated with the contents of “customer name” field, a “customer industry” field, a “customer markets” field, a “narrative” field, and/or any other fields of the CRM database which may enable the case study to be used as a training/learning tool for closing future sales opportunities.

In block 710, the case study is tagged with one or more tags selected according to the rules defined in block 704. For example, the case study may tagged with a tag that corresponds to the industry of the closed sales opportunity.

In block 712, the case study is posted to the electronic forum. For example, the case study is posted as the first post of a new thread that is categorized according to one or more of the CRM fields included in the case study.

In block 714, a notification (e.g., SMS, MMS, email, intra-forum message, etc.) is sent to forum users whose account information indicates an interest and/or association with the case study (e.g., based on its contents and/or tags). For example, for a case study corresponding to a closed sales opportunity, a notification may be sent to other sales representatives working in related industries or with similar clients. As another example, to whom a notification of a case study is sent may be determined by a company's organizational structure (e.g., sent to particular departments, to a manager's direct reports, etc.).

In block 716, users of the forum login and view the case study. Additionally, the users may post comments/replies to the case study (e.g., share similar experiences or suggestions, ask questions pertaining to the case study, etc.)

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform processes as described herein.

Accordingly, the present method and/or system may be realized in hardware, software, or a combination of hardware and software. The present method and/or system may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

1. A method comprising:
generating, in a computing system comprising a customer relationship management (CRM) database and a server that hosts an electronic forum, a case study based on contents of said CRM database; and
posting said case study to said electronic forum, wherein:
said case study is generated in response to a change in contents of one or more first selected fields of one or more records of said CRM database;
said generating said case study comprises retrieving contents of one or more second fields of said one or more records of said CRM database in accordance with a case study content rule; and
a resulting post of said case study in said electronic forum comprises one or more user interface elements corresponding to said contents of said one or more second selected fields of said one or more records of said CRM database.

2. The method of claim 1, wherein said case study content rule is a user-defined rules stored in memory of said computing system.

3. The method of claim 1, wherein said one or more first selected fields are selected based on one or more user-defined rules stored in memory of said computing system.

4. The method of claim 2, comprising generating, by said computing system, a graphical user interface for creation of said case study content rules.

5. The method of claim 1, comprising automatically performing by said computing system:
determining which one or more of a plurality of tags to associate with said case study based on one or more user-defined tagging-rules stored in memory of said computing system;
associating, in memory of said computing system, said determined one or more tags with said case study; and
inserting one or more user interface elements corresponding to said determined one or more of said plurality of tags in said post.

6. The method of claim 5, comprising:
in response to said associating of said determined one or more tags with said case study, sending a notification of said case study to users of said electronic forum who have indicated an interest in said determined tags.

7. The method of claim 1, wherein said case study is posted as the first post in a new thread of said electronic forum.

8. A method comprising:
in a computing system comprising a customer relationship management (CRM) database and a server that hosts an electronic forum:
storing one or more first user-defined rules for generating a case study based on contents of said CRM database;
storing one or more second user-defined rules for determining when to post a case study to said electronic forum;
automatically generating and posting a case study to said electronic forum in response to a change in contents of one or more first fields of one or more records of said CRM database, wherein:
said generating said case study comprises retrieving contents of one or more second fields of said one or more records of said CRM database in accordance with a case study content rule; and
a resulting post of said case study in said electronic forum comprises one or more user interface elements corresponding to said contents of said one or more second fields of said one or more records of said CRM database.

9. The method of claim 8 comprising generating, by said computing system, a graphical user interface for creation of said one or more first user-defined rules, wherein said graphical user interface comprises interface elements for selecting which fields of said CRM are to have their contents placed in said case study.

10. The method of claim 8 comprising generating, by said computing system, a graphical user interface for creation of said one or more second user-defined rules, wherein said graphical user interface comprises interface elements for selecting one or more conditions and one or more fields of said CRM such that said automatic posting occurs in response to said one or more fields meeting said one or more conditions.

11. The method of claim 8, comprising:
determining which one or more of a plurality of tags to associate with said case study based on one or more third user-defined rules stored in memory of said computing system; and
associating, in memory of said computing system, said determined one or more tags with said case study.

12. The method of claim 11, comprising:
in response to said associating of said determined one or more tags with said case study, sending a notification of said case study to users of said electronic forum who have indicated an interest in said determined tags.

13. The method of claim 8, wherein said case study is posted as the first post in a new thread of said electronic forum.

14. A system comprising:
a computing system comprising a customer relationship management (CRM) database and a server that hosts an electronic forum, the computing system being configured to:
generate a case study based on contents of said CRM database; and
post said case study to said electronic forum, wherein:
said case study is generated in response to a change in contents of one or more first selected fields of one or more records of said CRM database;
said generation of said case study comprises retrieval of contents of one or more second fields of said one or more records of said CRM database in accordance with a case study content rule; and
a resulting post of said case study in said electronic forum comprises one or more user interface elements corresponding to said contents of said one or more second selected fields of said one or more records of said CRM database.

15. The system of claim 14, wherein said case study content rule is a user-defined rules stored in memory of said computing system.

16. The system of claim 14, wherein said one or more first selected fields are selected based on one or more user-defined rules stored in memory of said computing system.

17. The system of claim 14, wherein said computing system is configured to generate a graphical user interface for creation of said case study content rule.

18. The system of claim 14, wherein said computing system is configured to automatically:
determine which one or more of a plurality of tags to associate with said case study based on one or more user-defined tagging rules stored in memory of said computing system;
associate, in memory of said computing system, said determined one or more tags with said case study; and
inserting one or more user interface elements corresponding to said determined one or more of said plurality of tags in said post.

19. The system of claim 18, wherein said computing system is configured to:
in response to said association of said determined one or more tags with said case study, send a notification of said case study to users of said electronic forum who have indicated an interest in said determined tags.

20. The system of claim 14, wherein said case study is posted as the first post in a new thread of said electronic forum.
